(19) United States
(12) Patent Application Publication
(10) Pub. No.: US 2005/0171662 A1
(43) Pub. Date: Aug. 4, 2005

(54) Method and apparatus for wireless networks in wheel alignment systems

(76) Inventors: Timothy A. Strege, Sunset Hills, MO (US); David A. Voeller, St. Louis, MO (US); James W. McClenahan, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/094,587

(22) Filed: Mar. 30, 2005

Related U.S. Application Data
(63) Continuation-in-part of application No. 10/871,241, filed on Jun. 18, 2004.
Application No. 10/871,241 is a continuation of application No. 09/880,571, filed on Jun. 13, 2001, now Pat. No. 6,754,562.

(51) Int. Cl. G06F 19/00

(52) U.S. Cl. 701/33; 701/29

(57) ABSTRACT

A vehicle service system having a processing system operatively coupled to a transceiver compliant with the IEEE 802.15.4 standard physical layer. The transceiver is configured to establish a wireless communications link based on an IEEE 802.15.4 packet structure and modulation format between the processing system and at least one additional transceiver located in proximity to the vehicle service system, enabling the processing system to utilize the wireless communications link to receive data from a system or component associated with the additional transceiver.

### CROSS-REFERENCE TO RELATED APPLICATIONS

This application is a continuation-in-part of, and claims priority from, co-pending U.S. patent application Ser. No. 10/871,241 filed on Jun. 18, 2004, herein incorporated by reference, which in turn is a continuation of U.S. patent application Ser. No. 09/880,571 filed on Jun. 13, 2001, now U.S. Pat. No. 6,754,562 issued on Jun. 22, 2004, also herein incorporated by reference.

### STATEMENT REGARDING FEDERALLY SPONSORED RESEARCH

Not Applicable.

### BACKGROUND OF THE INVENTION

The present invention relates generally to vehicle service systems having a processing system configured to receive information to be utilized in performing a vehicle service, and more particularly, to a vehicle wheel alignment system having a processing system configured to utilize specific wireless communications standards and protocols to identify and communicate with a variety of proximally located external devices for the purpose of establishing a wireless network.

Traditional vehicle wheel alignment systems, such as shown in U.S. Pat. No. 4,381,548 to Grossman et al., herein incorporated by reference, utilize a computing device, typically a general purpose or IBM-PC compatible computer, configured with wheel alignment software, which is connected to one or more vehicle wheel alignment angle sensors. The processing system is configured with software to compute angular relationships of the vehicle wheel, as is described in U.S. Reissue Patent No. 33,144 to Hunter, et al., herein incorporated by reference, and typically is in communication with a variety of conventional input and output devices, such as keyboards, pointing devices, printers, displays, and audio components. Traditional vehicle wheel alignment sensors comprise angle transducers, such as shown in U.S. Pat. No. 5,489,983 to McClenahan et al., herein incorporated by reference, which are mounted to the wheels of a vehicle undergoing an alignment service, but may comprise camera systems, such as shown in U.S. Pat. No. 5,870,315 to January, herein incorporated by reference, designed to observe either the wheels themselves or targets mounted to the wheels, and to generate images from which alignment angles may be determined by the computing device.

In prior art wheel alignment systems, the individual wheel alignment sensors are connected to the processing system by means of data communication cables. As the wheel alignment systems evolved, the data communication cables have been replaced by wireless communications technologies such as infrared and radio-frequency communication links, wherein the processing system serves as a controller, transmitting instructions to the individual wheel alignment sensors, and receiving wheel alignment information in response. To avoid conflicting communications, individual wireless wheel alignment sensors employ a passive communications system which transmits information to the processing system only in response to specific instructions received there from.

In addition to requiring information from individual wheel alignment sensors, a wheel alignment system or other vehicle service system processing system requires information identifying the type of sensors which it is utilizing, information related to the vehicle undergoing service, and information identifying the manner and format of any output provided to the operator or technician. These various pieces of information are traditionally entered into the processing system manually, via the conventional input devices such as the keyboard or mouse.

As manual entry of information can be time consuming and repetitive, it would be advantageous to provide a vehicle wheel alignment system wherein individual components were capable of automatically accessing and communicating with a wireless micro-network including a variety of devices located in proximity to the wheel alignment or vehicle service system, and for automatically acquiring from or delivering to, these devices at least a portion of the information required to complete a vehicle wheel alignment or vehicle service procedure.

Emerging wireless communication technology enables devices and appliances to interconnect in the form of a mobile and amorphous networks capable of continually reconfiguring as elements are added and removed. Wireless technology allows easy connection between devices and components, such as smart handheld devices and stand-alone equipment (i.e. general purpose computers to peripherals, etc) without the restrictions of cables or wires. For example, devices employing the Bluetooth communications master-slave protocol can connect with multiple similarly configured devices located within a close proximity, forming a high-bandwidth, high-speed data network. The Bluetooth communications protocols include user authentication, data encryption and data hopping facilities to protect privacy and to automatically prevent signal interference and loss. These protocols enable automatic synchronization between Bluetooth-enabled devices, however, due to the high data rates for which Bluetooth communications protocols are designed, devices configured with Bluetooth transceivers are typically high energy consumption devices with short battery life times.

Since the typical communications between a vehicle service device and a vehicle service sensor or other vehicle service component do not require continuous or high bandwidth communications, it would be advantageous to provide a vehicle service device with the capacity to utilize wireless communications protocols and standards for configurations which are adapted for sensor and control systems, for low energy consumption, and which are capable of linking large numbers of devices.

### BRIEF SUMMARY OF THE INVENTION

Briefly stated, in one aspect, the present invention comprises an improved vehicle wheel alignment system processing system configured to utilize a low-power radio-frequency transceiver conforming to the IEEE 802.15.4 standard to communicate with any of a variety of similarly configured external components and devices brought into communications proximity with the vehicle wheel alignment system. The vehicle wheel alignment system and the devices with which it is in communication form an adaptable wireless network within which components and devices may be added and removed without disruption.

In an alternate embodiment, the present invention comprises an improved vehicle wheel alignment system configured to utilize a low-power radio-frequency transceiver and ZigBee protocol network and application interfaces to communicate with any of a variety of similarly configured external components and devices brought into communications proximity with the vehicle wheel alignment system. The vehicle wheel alignment system and the devices with which it is in communication form a wireless network into which components and devices may be added and removed without disruption.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an overview of prior art components in a vehicle wheel alignment system;

FIG. 2 is a block diagram illustrating a vehicle wheel alignment system of the present invention in wireless communication via a star-topology wireless network with a plurality of external devices;

FIG. 3 is a block diagram illustrating a vehicle wheel alignment system of the present invention in wireless communication via a peer-to-peer topology wireless network with a plurality of external devices; and

FIG. 4 is an illustration of the prior art ZigBee stack system requirements.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

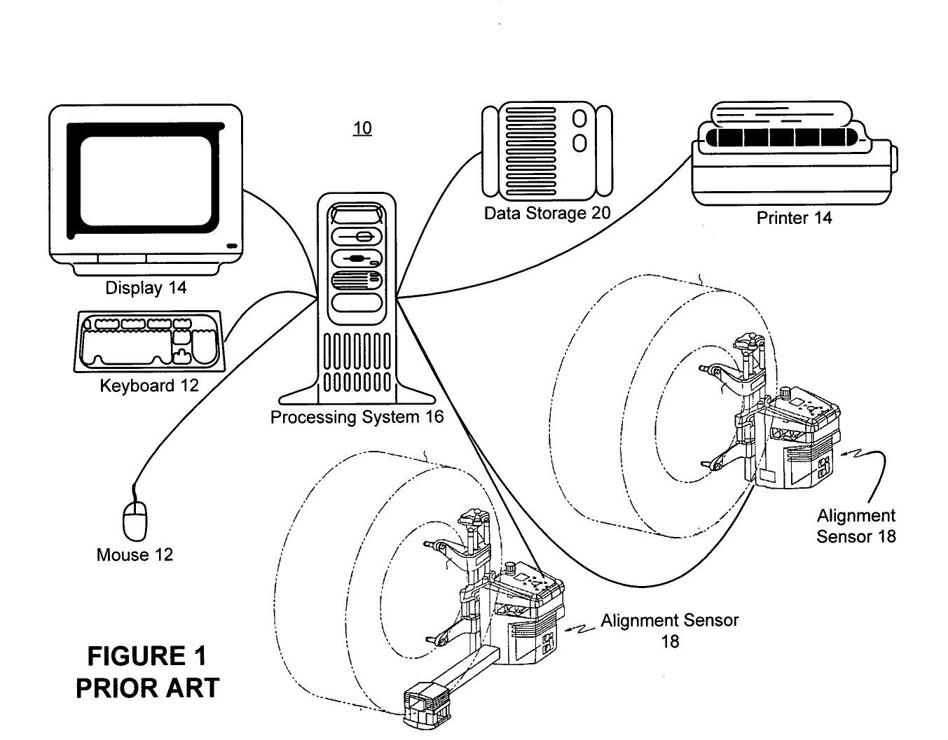

Turning to the figures, and to FIG. 1 specifically, there is shown the components of a prior art vehicle wheel alignment system generally at 10. The vehicle alignment system 10 includes at least one input device 12, such as a keyboard, mouse, microphone, or touch screen, for use by an operator or technician (not shown) to communicate with the vehicle alignment system 10, and at least one output device 14, such as a visual display or audio speaker for the alignment system 10 to convey information to the operator or technician.

Depending upon the needs of the operator or technician, the input devices 12 and output devices 14 may include, but are not limited to, one or more of the following conventional devices such as a keyboard, a pointing device, a remote control device, a monitor or LCD display, or audio components. The devices can be integrated together in a console, or located separately, again depending upon the needs of the operator and the configuration of the wheel alignment system 10.

The input devices 12 and output devices 14 are in communication with a processing system 16 such as a wheel alignment computer, operating under control of one or more software programs or components. The processing system 16 can be any processing system used with systems of complexity similar to that of a vehicle wheel alignment system. For example, a micro-processor, a micro-controller, a digital signal processor having sufficient computing power, or a general purpose computer can be used as the processing system. Of course, any equivalent device, i.e. one capable of executing the requisite software programs or software components, can also be used. Communication between the input devices 12, output devices 14, and the processing system 16 can be performed electronically or electro-magnetically (including optical communications such as infrared system), or by any combination thereof.

The processing system 16 of the vehicle wheel alignment system 10 is operatively connected to at least one alignment angle sensing device 18 for obtaining measurements of an alignment angle and/or characteristic of a vehicle 11 under test. The sensing devices 18, depending upon the application and requirements, can be electronic, electromechanical, or optical. The sensing devices 18 can be hard-wired to the processing system 16 for communication therewith, or can be in communication with the processing system 16 in any other suitable manner, such as through infrared or radio-frequency communication.

In addition to the input devices 12, output devices 14, and sensing devices 18, the processing system 16 of the vehicle wheel alignment system 10 can be configured with access to an internal or external data storage component (collectively identified as 20), and to various peripheral components, such as printers, CD-ROM drives, DVD-drives, and/or a communications network such as the Internet.

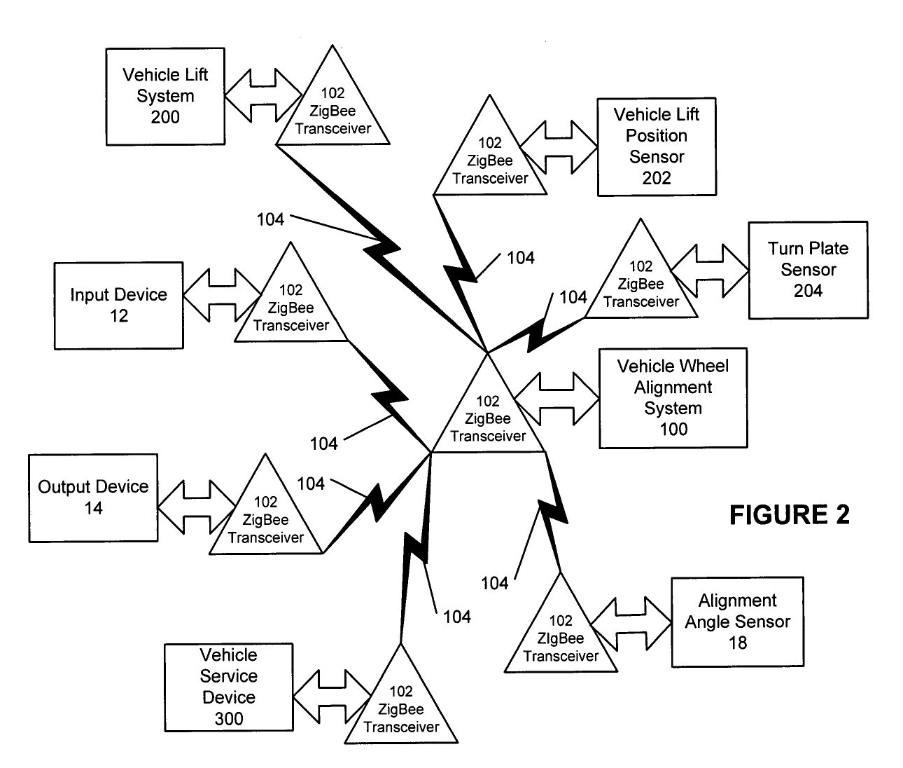

Turning to FIG. 2, an embodiment of a vehicle wheel alignment system 100 is configured with a transceiver 102 for establishing a short-range, low power wireless network compliant with the IEEE 802.15.4 standard physical (PHY) layer for establishing a wireless communication link or network based on the 802.15.4 packet structure and modulation format with similarly configured peripheral components and external devices, each of which includes at least a corresponding transceiver 102 and an associated processing system or suitable microprocessor operatively coupled there to. The IEEE 802.15.4 standard for Wireless Medium Access Control (MAC) and Physical Layer (PHY) Specifications for Low-Rate Wireless Personal Area Networks (LR-WPANs) is available from the Institute of Electrical and Electronics Engineers, Inc. of New York, N.Y., and is herein incorporated by reference.

Optionally, the transceiver 102 conforms to the IEEE 802.15.4 standard physical layer and medium access control (MAC) to establish full IEEE 802.15.4 compliant communication links or networks, or to the IEEE 820.15.4 PHY, MAC, and Zigbee Protocol Stacks to establish wireless communication links 104 and networks utilizing the ZigBee communications protocol with similarly configured peripheral components and external devices.

The peripheral components generally include, but are not limited to, any components associated with a prior art vehicle wheel alignment system which are provided with suitable transceivers 102, such as input devices 12, output devices 14, and vehicle wheel alignment sensors 18, which may be either convention wheel-mounted sensors, or remotely-mounted imaging sensors. The external devices generally include devices which are independent of the vehicle wheel alignment system 100 and which are configured with suitable transceivers 102, such as, but not limited to, vehicles 11 undergoing service, a vehicle lift system 200, vehicle lift system position sensors 202, turn plate sensors 204, and other vehicle service devices 300.

It is preferred that the transceivers 102 associated with the vehicle wheel alignment system 100 and similarly configured devices which are in communication to form the wireless network, operate in the 2.4 GHz, 868 MHz, or 915 MHz radio-frequency bands. Each transceiver 102 is operatively coupled to an associated processing system or microcontroller, and is preferably a low-powered device, capable of data rates of 250 Kbps @ 2.4 GHz, 40 kbps @ 915 MHz, and 20 kbps @ 868 MHz, which is optimized for low duty-cycle and extended battery life applications which may be on the order of months, years, or decades. Exemplary transceivers 102 are sold under the designations MC13191, MC13912, and MC13193 by Freescale Semiconductor, Inc., and requires a 2.7V DC power source, using a maximum of 800 μA when idle, 35 mA when operating in a transmit mode, and 42 mA when operating in a receive mode. Preferably, each transceiver 102 includes a low noise amplifier, a 1.0 mW power amplifier, a voltage controlled oscillator, an on-board power supply regulation, and full spread-spectrum encoding and decoding. The transceivers 102 additionally preferably support 250 kbps Offset-Quadrature Phase Shift Keying data in 2.0 MHz channels with 5.0 MHz channel spacing.

When coupled to the associated processing systems, microprocessors, or microcontrollers, and configured with suitable software, the transceivers 102 are capable of interconnecting into multiple topologies of wireless networks, such as those consistent with devices employing the current IEEE 802.15.4 standard and ZigBee communications protocols. Such low power transceivers 102 are particularly suited for use with a vehicle wheel alignment system 100 or other vehicle service system operating in a vehicle service center, and which are unlikely to require communication with devices other than those located within the general proximity of the vehicle service center. The low power requirements and extended battery life operating parameters of each transceiver 102 enable the inclusion of wireless communication features in peripheral and external devices in which such inclusion has previously been considered impractical due to power consumption requirements and the need for frequent battery replenishments such as changes or recharges. Depending upon the particular function of the peripheral or external devices, the transceivers 102 associated therewith are preferably configured to operate for at least months, years, or possibly decades between battery replenishments.

For example, a peripheral device configured with a transceiver 102, and having a power supply consisting of a single AAA alkaline battery could remain connected to a wireless network associated with a vehicle wheel alignment system 100 for over two years before requiring a battery replenishment, assuming data transmission is limited to approximately 0.1% of the total time during which the peripheral device is connected.

Both fixed and mobile peripheral and external devices may be in wireless communication with the vehicle wheel alignment system 100 via the wireless network. For example, a vehicle 11 equipped with a suitable transceiver 102 conforming to the IEEE 802.15.4 standard physical layer brought into communication proximity with the vehicle wheel alignment system 100, may establish a communications link with the vehicle wheel alignment system 100 as required to communicate data. In the case of a vehicle 11, the suitable transceiver 102 may be incorporated into the vehicle 11, or may comprise a detachable unit designed to couple to an access point to the vehicle's systems, thereby providing wireless access thereto. Utilizing this communications link, the vehicle wheel alignment system 100, or other device linked to the wireless network, can communicate with components of the vehicle 11, such as a vehicle electronic control module (ECM).

Information which may be exchanged with a vehicle 11 via a wireless network may include, but is not limited to, diagnostic information stored in one of the vehicle's electronic control modules (ECMs). This may include, for example, the vehicle identification number (VIN), vehicle tire pressure from associated tire pressure sensors, stored error codes, steering wheel position encoder signals, braking system status, braking hydraulic pressure readings, brake pedal pressure, tire pressure, vehicle wheel speed, electronic ride-height system signals, rear wheel steering information, brake actuation signals, engine status information, power steering status information, and throttle position sensor signals.

Additional information which can be stored in a vehicle ECM, and communicated to the vehicle wheel alignment system 100 or other vehicle service device 300 over the wireless network may include vehicle specifications and previous vehicle service information such as previous alignment measurements, last service date, and the name or location of the service shop performing the last vehicle service.

In addition to receiving information from a vehicle 11, the vehicle wheel alignment system 100, or other vehicle service system, can communicate via the wireless network with integrated sensors and components on the vehicle 11, such as to direct their operation or to store data in an onboard vehicle storage memory. For example, upon completion of a vehicle wheel alignment procedure, the vehicle wheel alignment system 100 of the present invention can communicate the vehicle's current alignment measurements to the vehicle storage memory via the wireless network.

Another example includes a vehicle wheel alignment steering procedure of the vehicle wheel alignment system 100 commanding the vehicle 11 to steer the wheels of a steer-by-wire steering system to a specified position before at least one measurement is taken. The position the wheels are steered to by the vehicle can be measured by the vehicle wheel alignment system 100 and correspondingly verified. If the steered position of the wheels is outside the specified value and tolerance, appropriate measures can be taken. An example of an appropriate measure might be to change a steered straight ahead value stored in the vehicle 11 that is used as a reference for how far the vehicle wheels have been steered.

It is anticipated that a vehicle wheel alignment system 100 of the present invention can simultaneously be in wireless communication with more than one similarly configured device, thereby establishing an adaptable wireless network wherein data can be exchanged between the devices. As additional devices move, or are brought into, communications proximity to the wireless network, they are automatically or manually added to the wireless network if they are successfully authenticated. Alternatively, as devices move, or are removed, from communications proximity to the wireless network, they are removed from the wireless network.

The vehicle wheel alignment system 100 may be configured to identify when a specific device is added to, or removed from the wireless network. For example, a portable peripheral device such as a remote control or display device configured with a transceiver 102 can be monitored by the vehicle wheel alignment system 100 to detect when the portable peripheral device is removed from the wireless network. In the case of remote control or remove display devices, an operator may be provided with a suitable warning in the event a monitored device is removed from the network, such as may occur if it has been left in a customer's vehicle, as the device will be removed from the wireless network when the vehicle exits the service facility, enabling the operator to take suitable corrective action in a prompt manner. Optionally, the vehicle wheel alignment system 100 may be configured to transmit a locator signal to specific devices coupled to the wireless network, directing them to provide an audible or visible signal to an operator to assist in identifying the physical location of the specific devices.

Similarly, individual devices themselves can be configured to provide a signal to an operator indicating the disruption of a communications link to the wireless network. For example, a remove control or display device may be configured with a means to emit an audible warning if the remote control or display device is removed from communication proximity to the wireless network.

In contrast with passive network prior art systems wherein only a single device functions as a network control device, transmitting instructions to connected devices, and receiving information there from only in response to the transmitted instructions, the IEEE 802.15.4 standard physical layer, the optional MAC standard layer and ZigBee protocols employed by the vehicle wheel alignment system 100 permit the establishment of multiple wireless network topologies, including star, peer-to-peer, and mesh networks which consist of at least one fully functioning device operating as a node or network control device, and which may be interconnected via the wireless network to other fully functioning devices or to reduced function devices.

In a star wireless network topology, such as shown in FIG. 2, the vehicle wheel alignment system 100, or other vehicle service device 300, functions as a central network controller. All other devices operatively linked to the wireless network in a star topology are reduced function devices which communicate using the IEEE 802.15.4 packet structure and modulation only through the vehicle wheel alignment system 100 or other vehicle service device 300 functioning as the central network controller.

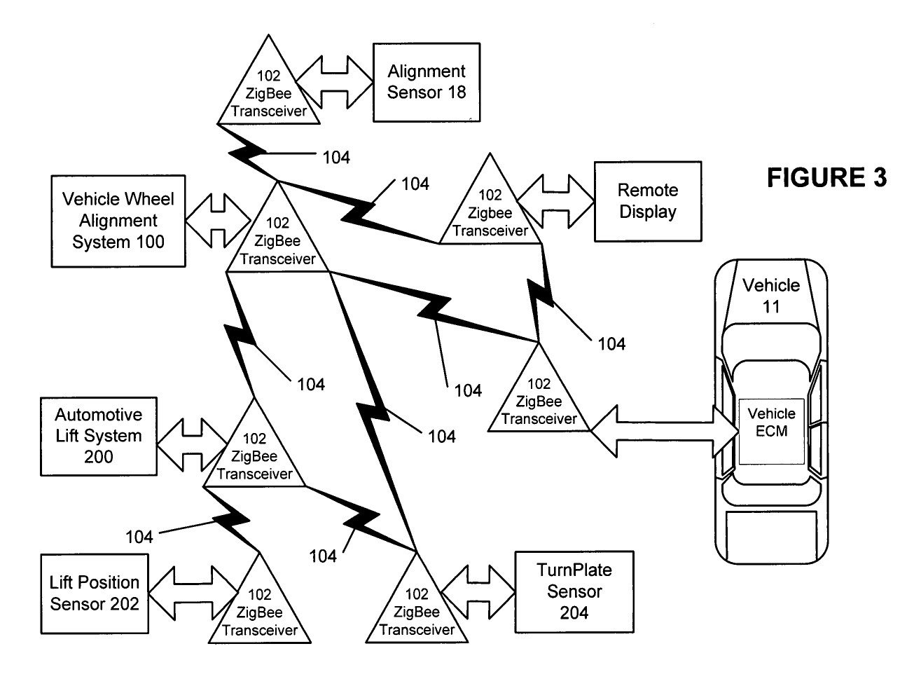

In a peer-to-peer or mesh wireless network topology, such as shown in FIG. 3, the vehicle wheel alignment system 100 functions to coordinate communication over the wireless network with reduced function end-point devices which are operatively linked only to the vehicle wheel alignment system 100, and to communicate with one or more similarly configured peer devices which also function to coordinate communications with directly associated reduced function end-point components.

Additional fully functional devices on the peer-to-peer wireless network are capable of communicating with each other directly, without communicating through the vehicle wheel alignment system 100, providing redundant data pathways between some components on the wireless network. For example, as shown in FIG. 3, the vehicle wheel alignment system 100 can communicate with an automotive lift system 200 to acquire data from a lift position sensor 202 or a turn plate sensor 204, or alternatively, may communicate directly with the turn plate sensor 204.

Peripheral and external devices which are in wireless communication with the vehicle wheel alignment system 100 via the transceiver 102 may be low-duty cycle devices, and are not required to maintain continuous wireless contact with the vehicle wheel alignment system 100. For example, devices which to not need to receive data from the vehicle wheel alignment system 100 may be configured according to the IEEE 802.15.4 PHY and MAC standards and ZigBee protocols to quickly attach to the wireless network, transmit required information, detach from the wireless network, and return to a “sleep” state to achieve a very long battery life. Devices which are suitable for this mode of operation may include, but are not limited to, external sensors such as vehicle lift position sensors 202, turn plate sensors 204, and other sensors which collect data which does not change rapidly during a vehicle service procedure.

Vehicle service systems and vehicle wheel alignment system 100 configured with wireless communication networks conforming to the IEEE 802.15.4 standards, and optionally with the ZigBee protocols, for communicating between peripheral and external components preferably provide for several different types of communication traffic on the wireless network. This traffic may including periodic data communicated at a rate defined the by particular application generating it (i.e. sensors), intermittent data communicated at a rate defined by an external stimulus (i.e. user activation), and repetitive low latency data communicated in allocated time slots (i.e. input devices such as a mouse or touchpad, wheel alignment angle sensors during a vehicle wheel alignment procedure). Periodically communicated data can be handled using a beaconing system whereby the sensor sending the data “awakes” for a beacon signal, checks for any messages, and returns to a “sleep” mode, conserving power. Intermittent data can be handled either in a beaconless system or in a disconnected fashion wherein the device only establishes a communications link to the wireless network when data is available for communications, conserving power. Low-latency applications utilizing a guaranteed time slot are allocated specific durations of time within predetermined data frames to either communicate data or remain silent.

Within the wireless communications network associated with the vehicle wheel alignment system 100 or vehicle service device 300, all transceivers and associated devices are provided with 64-bit IEEE addresses. At least one of the transceivers 102, such as the one associated with a processing system 16 of the vehicle wheel alignment system 100 are configured as full function devices (FFD) which are capable of operating in any topology of the wireless communication network, which can coordinate network traffic, and which can communicate with any other device operatively coupled to the wireless communications network. Other transceivers 102, such as those associated with peripheral devices and external devices, may be reduced function devices (RFD), which are limited to operation in a star topology of the wireless communication network, and can communicate only with a network coordinate device, such as the processing system of the vehicle wheel alignment system 100.

In an embodiment of the present invention, communication of data between the wireless transceivers 102 utilizes data frame structures defined by the IEEE 802.15.4 medium access control (MAC) standard. The data frame structures have been designed to keep the complexity to a minimum while at the same time making them sufficiently robust for wireless transmission in a noisy environment. Each successive protocol layer adds to the structure with layer-specific headers and footers. The IEEE 802.15.4 MAC defines four frame structures: (1) a beacon frame, used by a network coordinator transceiver 102 to transmit beacons; (2) a data frame, used for all transfers of data between transceivers 102; (3) an acknowledgment frame, used for confirming successful frame reception at a transceiver 102; and (4) a MAC command frame, used for handling all MAC peer entity control transfers.

In an embodiment of the present invention, the IEEE 802.15.4 standard and ZigBee protocol allows the optional use of a superframe structure to communicate data between transceivers 102. The format of the superframe is defined by the transceiver 102 identified as the network coordinator. The superframe is bounded by network beacons, and is sent by the network coordinator transceiver. The superframe is divided into 16 equally sized slots. The beacon frame is transmitted in the first slot of each superframe. If a network coordinator transceiver 102 elects not to use a superframe structure it may turn off the beacon transmissions. The beacons are used to synchronize the peripheral and external devices linked to the wireless communication network by transceivers 102, to identify the transceiver 102 established as the network coordinate, and to describe the structure of the superframes. Any peripheral or external device wishing to communicate during the contention access period (CAP) between two beacons competes with other peripheral or external devices using a slotted CSMA-CA communication mechanism. All transactions shall be completed by the time of the next network beacon.

For low latency devices or devices requiring specific data bandwidth, the network coordinator may dedicate portions of the active superframe to those peripheral or external devices. These portions are identified as guaranteed time slots (GTSs). The guaranteed time slots comprise the contention free period (CFP), which always appears at the end of the active superframe starting at a slot boundary immediately following the CAP. The network coordinator may allocate up to seven of these GTSs and a GTS may occupy more than one slot period. However, a sufficient portion of the CAP shall remain for contention based access of other networked devices or new devices wishing to join the network. All contention based transactions shall be complete before the CFP begins. Also each device transmitting in a GTS shall ensure that its transaction is complete before the time of the next GTS or the end of the CFP.

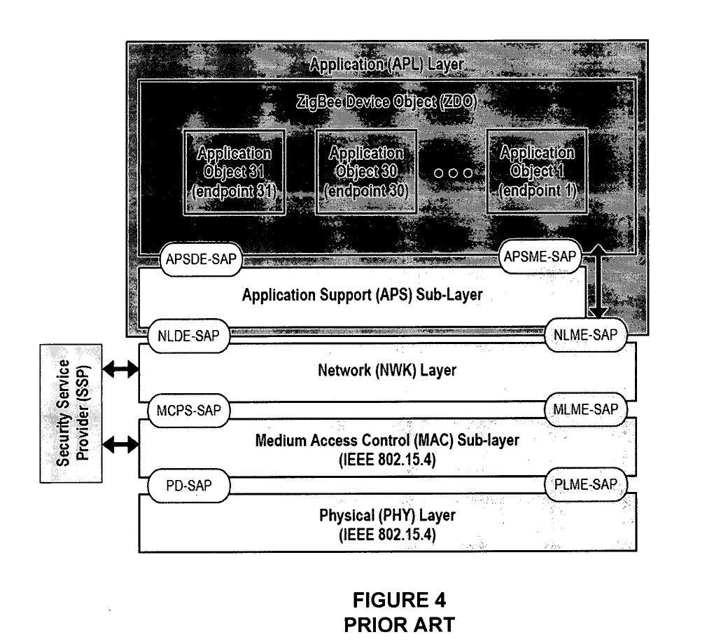

As shown in FIG. 4, the ZigBee protocol, builds upon the IEEE 802.15.4 standard to provide a multi-layer system stack for each node in a wireless communications network between transceivers 102. The physical layer (PHY) of each transceiver 102 conforms to the 802.15.4 standard for hardware requirements. Above the physical layer is the medium access control (MAC) sub-layer. The network (NWK) layer builds on the MAC sub-layer, and is responsible for starting new networks, providing the ability of a device to join or leave a network, configure the stack for a requested operation, providing the ability of a network coordinator to assign an address to each device joining a network, synchronize with other compatible devices through either tracking beacons or polling, securing, and routing of data.

The ZigBee application layer consists of the Application support (APS) sub-layer, the ZigBee Device Object (ZDO) and the manufacturer-defined application objects. The responsibilities of the APS sub-layer include maintaining tables for binding, which is the ability to match two devices together based on their services and their needs, and forwarding messages between bound devices. Another responsibility of the APS sub-layer is discovery, which is the ability to determine which other devices are operating in the personal operating space of a device. The responsibilities of the ZDO include defining the role of the device within the network (e.g., ZigBee network coordinator or end device), initiating and/or responding to binding requests and establishing a secure relationship between network devices over the wireless communication network. The manufacturer-defined application objects implement the actual applications according to the ZigBee-defined application descriptions.

When security of the MAC layer data frame is desired, the ZigBee protocol provides for MAC layer security to secure MAC command, beacon, and acknowledgement data frames. The ZigBee protocol may secure messages transmitted over a single hop using secured MAC data frames, but for multi-hop messaging the ZigBee protocol relies upon upper layers (such as the network layer) for security. The MAC layer uses the Advanced Encryption Standard (AES) as its core cryptographic algorithm and describes a variety of security suites that use the AES algorithm. These suites can protect the confidentiality, integrity, and authenticity of MAC frames. The MAC layer does the security processing, but the upper layers, which set up the keys and determine the security levels to use, control this processing. When the MAC layer transmits (receives) a data frame with security enabled, it looks at the destination (source) of the data frame, retrieves the key associated with that destination (source), and then uses this key to process the data frame according to the security suite designated for the key being used. Each key is associated with a single security suite and the MAC data frame header has a bit that specifies whether security for a data frame is enabled or disabled. A vehicle wheel alignment system 100 or vehicle service device 300 of the present invention configured with a transceiver 102 and processing system/microcontroller to utilize the IEEE 802.15.4 standard and ZigBee protocol for wireless communication may optionally utilize the associated security features for communication between transceivers 102 over a wireless network.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved vehicle service system having a processing system, said improvement comprising:
a transceiver operatively coupled to said processing system, said transceiver configured with an IEEE 802.15.4 standard physical layer to establish a wireless communications link between said processing system and at least one additional transceiver in proximity to the vehicle service system utilizing an IEEE 802.15.4 packet structure and modulation format; and
wherein said processing system is configured to utilize said communications link to at least receive data from said at least one additional transceiver.

2. The improved vehicle service system of claim 1 wherein said transceiver is further configured with IEEE 802.15.4 standard medium access control.

3. The improved vehicle service system of claim 2 wherein said transceiver is further configured with a ZigBee protocol stack; and
wherein wireless communications link further conforms to a ZigBee communication protocol.

4. The improved vehicle service system of claim 1 wherein said at least one additional transceiver is operatively coupled to a peripheral component of the vehicle service system.

5. The improved vehicle service system of claim 4 wherein said peripheral component is an output device.

6. The improved vehicle service system of claim 4 wherein said peripheral component is an input device.

7. The improved vehicle service system of claim 4 wherein said peripheral component is a battery operated device.

8. The improved vehicle service system of claim 7 wherein said peripheral device is configured for low power consumption.

9. The improved vehicle service system of claim 7 wherein said peripheral device is configured to operate for at least a month between battery replenishments.

10. The improved vehicle service system of claim 7 wherein said peripheral device is configured to operate for at least a year between battery replenishments.

11. The improved vehicle service system of claim 4 wherein said peripheral component is a sensor configured to acquire data.

12. The improved vehicle service system of claim 1 wherein said processing system is configured to utilize said communications link to direct operation of a device operatively coupled to said at least one additional transceiver.

13. The improved vehicle service system of claim 1 wherein said transceiver is further configured to establish a plurality of wireless communication links conforming to an IEEE 802.15.4 standard between said processing system and a plurality of additional transceivers in proximity to the vehicle service system.

14. The improved vehicle service system of claim 13 wherein said plurality of wireless communication links define a star topology wireless network.

15. The improved vehicle service system of claim 1 wherein said transceiver is further configured with an IEEE 802.15.4 standard medium access control layer and a ZigBee protocol stack to establish a plurality of wireless communication links conforming to a ZigBee communication protocol between said processing system and a plurality of additional transceivers in proximity to the vehicle service system; and
wherein said plurality of wireless communication links define a portion of a peer-to-peer topology wireless network.

16. The improved vehicle service system of claim 1 wherein said transceiver is further configured with an IEEE 802.15.4 standard medium access control layer and a ZigBee protocol stack to establish a plurality of wireless communication links conforming to a ZigBee communication protocol between said processing system and a plurality of additional transceivers in proximity to the vehicle service system; and
wherein said plurality of wireless communication links define a portion of a mesh topology wireless network.

17. The improved vehicle service system of claim 1 wherein said at least one additional transceiver is operatively coupled to an external device which is independent of the vehicle service system.

18. The improved vehicle service system of claim 17 wherein said external device is a second vehicle service system.

19. The improved vehicle service system of claim 17 wherein said external device is a peripheral component of a second vehicle service system.

20. The improved vehicle service system of claim 17 wherein said external device is a component of a vehicle.

21. The improved vehicle service system of claim 1 wherein said vehicle service system is a vehicle wheel alignment system.

22. The improved vehicle service system of claim 1 wherein said processing system is configured to utilize said communications link to transmit data to said at least one additional transceiver.

23. The improved vehicle service system of claim 1 wherein said vehicle service system is a vehicle wheel balancing system.

24. The improved vehicle service system of claim 1 wherein said processing system is further configured to monitor said communications link; and
wherein said processing system is further configure to provide an indication of a loss of said monitored communications link.

25. The improved vehicle service system of claim 1 wherein a microprocessor operatively coupled said at least one additional transceiver is configured to monitor said communications link; and
wherein said microprocessor is further configured to provide an indication of a loss of said monitored communications link.

26. An improved vehicle service system having a processing system, said improvement comprising:
a transceiver operatively coupled to said processing system, said transceiver configured to establish at least one wireless communications link optimized for low duty-cycle applications between said processing system and at least one additional transceiver in proximity to the vehicle service system; and
wherein said processing system is configured to utilize said at least one communications link to at least receive data from said at least one additional transceiver.

27. The improved vehicle service system of claim 26 wherein said wireless communications link is based on IEEE 802.15.4 packet structure and modulation format.

28. The improved vehicle service system of claim 26 wherein said transceiver is further configured to establish a plurality of said wireless communications links, said plurality of wireless communication links defining at least a portion of a wireless communications network having a topology selected from a set of topologies including star, peer-to-peer, and mesh.

29. The improved vehicle service system of claim 26 wherein said at least one additional transceiver is battery powered and configured for a low power consumption operation.

30. The improved vehicle service system of claim 26 wherein said processing system is further configured to monitor said communications link; and
wherein said processing system is further configure to provide an indication of a loss of said monitored communications link.

31. An improved vehicle wheel alignment system including a processing system configured with at least one vehicle wheel alignment software application, at least one input device for receiving operator commands, at least one output device for displaying vehicle wheel alignment-related information, and a plurality of wheel alignment sensors, the improvement comprising:
a network coordinator radio-frequency transceiver operatively coupled to the processing system;
a radio-frequency transceiver operatively coupled to the at least one input device;
a radio-frequency transceiver operatively coupled to the at least one output device;
each of the plurality of wheel alignment sensors operatively coupled to an associated radio-frequency transceiver; and
wherein each of said radio-frequency transceivers is configured to communicate with said network coordinator radio-frequency transceiver using an IEEE 802.15.4 standard packet structure and modulation format.

32. The improved vehicle wheel alignment system of claim 31 wherein each of said radio-frequency transceivers is configured to communicate with said network coordinator radio-frequency transceiver using a ZigBee communication protocol.

33. The improved vehicle wheel alignment system of claim 31 further including at least one external device configured with a radio-frequency transceiver in operative wireless communication with said network coordinator radio-frequency transceiver using said IEEE 802.15.4 standard packet structure and modulation format.

34. The improved vehicle wheel alignment system of claim 33 wherein said external device is a vehicle service system.

35. The improved vehicle wheel alignment system of claim 33 wherein said external device is a sensor associated with a vehicle service system.

36. The improved vehicle wheel alignment system of claim 33 wherein said radio-frequency transceiver associated with said at least one external device is a second network coordinator radio-frequency transceiver.

37. The improved vehicle wheel alignment system of claim 31 wherein each of said radio-frequency transceivers is compliant with the IEEE 802.14.5 standard physical layer.

38. The improved vehicle wheel alignment system of claim 37 wherein each of said radio-frequency transceivers is compliant with the IEEE 802.14.5 standard medium access control.

39. The improved vehicle wheel alignment system of claim 38 wherein each of said radio-frequency transceivers is configured with a ZigBee protocol stack.

40. The improved vehicle service system of claim 31 wherein at least one of said radio-frequency transceivers is battery powered and configured for a low power consumption operation.

41. The improved vehicle wheel alignment system of claim 31 wherein said processing system is configured to monitor a communication link between said network coordinator radio-frequency transceiver and at least one radio-frequency transceiver; and
wherein said processing system is further configure to provide an indication responsive to a loss of said monitored communication link.
